(19) United States
(12) Patent Application Publication
(10) Pub. No.: US 2010/0248012 A1
(43) Pub. Date: Sep. 30, 2010

(54) Alkaline Batteries

(76) Inventors: Alexander Boris Shelekhin, Ridgefield, CT (US); Nikolai Nikolaevich Issaev, Woodbridge, CT (US); David Lloyd Anglin, Brookfield, CT (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/412,924

(22) Filed: Mar. 27, 2009

(51) Int. Cl. H01M 2/02

(52) U.S. Cl. 429/163

(57) ABSTRACT

An AA alkaline cell is described. The cell includes a housing and within the housing an anode, a cathode, a separator disposed between the cathode and the anode, and an electrolyte. The anode may include about 3.3 grams of zinc particles. The cathode may include a cathode active material. The electrolyte may include an ionically conductive component in an aqueous solution. The AA alkaline cell may have a TA/Concentration ratio greater than about 4800.

### FIELD OF THE INVENTION

This invention relates to alkaline cells.

### BACKGROUND OF THE INVENTION

Alkaline cells (batteries) are commonly used as electrical energy sources. An alkaline cell contains a negative electrode, typically called the anode, and a positive electrode, typically called the cathode. The anode contains an active material that can be oxidized. The cathode contains an active material that can be reduced. The anode active material is capable of reducing the cathode active material. A separator is disposed between the anode and cathode. These components are disposed in a metal can.

When an alkaline cell is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the alkaline cell during discharge.

There is a growing need to improve the overall performance of batteries. In today's batteries the zinc material of the anode is subject to passivation. During passivation an oxide layer may form on the surface of the zinc. Formation of this oxide layer on the zinc may reduce the overall performance of the alkaline cell when used in a device. Passivation may be reduced and overall performance may be increased by adjusting the ratio of the surface area of the anode material to the salt concentration within the electrolyte.

### SUMMARY OF THE INVENTION

One aspect of the invention features an AA alkaline cell. The cell comprises a housing and within the housing, an anode comprising at least about 3.3 grams of zinc particles; a cathode comprising a cathode active material; a separator disposed between the cathode and the anode; and an electrolyte comprising an ionically conductive component in an aqueous solution. The AA alkaline cell has a TA/Concentration ratio of greater than about 4800.

In some implementations, the cathode active material may be manganese dioxide, electrolytic manganese dioxide (EMD), chemical manganese dioxide (CMD) and high power electrolytic manganese dioxide (HP EMD). The cathode may include graphite in a concentration of less than about 3.75% by weight. The cathode may include carbon particles. The carbon particles may include expanded graphite. The zinc particles may have a particle surface area of less than 9.62×10⁻⁴ cm². The ionically conductive component may be an alkali hydroxide. The ionically conductive component may include a salt.

Another aspect of the invention features an AAA alkaline cell. The cell comprises a housing and within the housing, an anode comprising at least about 1.9 grams of zinc particles; a cathode comprising a cathode active material; a separator disposed between the cathode and the anode; and an electrolyte comprising an ionically conductive component in an aqueous solution. The AAA alkaline cell has a TA/Concentration ratio of greater than about 1700.

In some implementations, the cathode active material may be manganese dioxide, electrolytic manganese dioxide (EMD), chemical manganese dioxide (CMD) and high power electrolytic manganese dioxide (HP EMD). The cathode may include graphite in a concentration of less than about 3.75% by weight. The cathode may include carbon particles. The carbon particles may include expanded graphite. The zinc particles may have a particle surface area of less than 9.62×10⁻⁴ cm². The ionically conductive component may be an alkali hydroxide. The ionically conductive component may include a salt.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawing.

FIG. 1 is a schematic diagram of a alkaline cell.

### DETAILED DESCRIPTION OF THE INVENTION

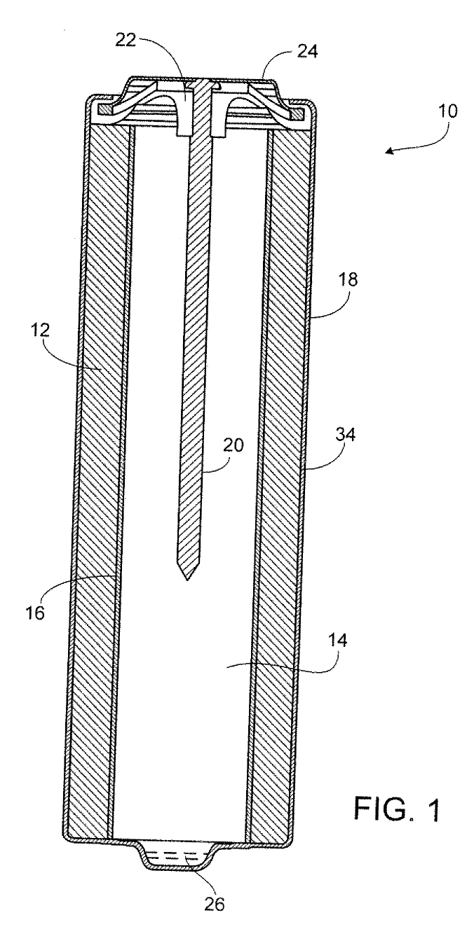

Referring to FIG. 1, alkaline cell 10 includes a cathode 12, an anode 14, a separator 16 and a cylindrical housing 18. Alkaline cell 10 also includes current collector 20, seal 22, and a negative metal end cap 24, which serves as the negative terminal for the alkaline cell. A positive pip 26, which serves the positive terminal of the alkaline cell, is at the opposite end of the alkaline cell from the negative terminal. An electrolytic solution is dispersed throughout alkaline cell 10. Alkaline cell 10 can be an AA, AAA, AAAA, C, or D alkaline cell.

The cylindrical housing 18 may be thin walled, e.g., typically from 0.25 mm to 0.15 mm wall thickness for AA and AAA cells, and 0.30 mm to 0.20 mm for C and D cells.

Cathode 12 includes one or more cathode active materials. Preferably, the cathode active material is selected from the group consisting of manganese dioxide, electrolytic manganese dioxide (EMD), chemical manganese dioxide (CMD) and high power electrolytic manganese dioxide (HP EMD). Examples of other cathode active materials include but are not limited to nickel oxyhydroxide, silver oxide, or copper oxide.

A preferred cathode active material is manganese dioxide, having a purity of at least about 91 percent by weight. Electrolytic manganese dioxide (EMD) is a preferred form of manganese dioxide for electrochemical cells because of its high density and since it is conveniently obtained at high purity by electrolytic methods. Chemical manganese dioxide (CMD), a chemically synthesized manganese dioxide, has also been used as cathode active material in electrochemical cells including alkaline cells and heavy duty cells.

EMD is typically manufactured from direct electrolysis of a bath of manganese sulfate and sulfuric acid. Processes for the manufacture of EMD and its properties appear in Batteries, edited by Karl V. Kordesch, Marcel Dekker, Inc., New York, Vol. 1, (1974), p. 433-488. CMD is typically made by a process known in the art as the “Sedema process”, a chemical process disclosed by U.S. Pat. No. 2,956,860 (Welsh) for the manufacture of alkaline cell grade MnO₂ by employing the reaction mixture of MnSO₄ and an alkali metal chlorate, preferably NaClO₃. Distributors of manganese dioxides include Kerr McGee Co. (Trona D), Chem Metals Co., Tosoh, Delta Manganese, Mitsui Chemicals, JMC, and Xiangtan.

In some preferred implementations, particularly when very low or no cell distortion is required, high power (HP) EMD may be used. Preferably, the HP EMD has an open circuit voltage (OCV) of at least 1.635. A suitable HP EMD is commercially available from Tronox, under the trade name High Drain.

The cathode 12 may also include carbon particles and a binder. The cathode may also include other additives. The cathode 12 will have a porosity. The cathode porosity is preferably between about 22% and about 31%. The cathode porosity is a calculated value based on the cathode at the time of manufacturing. The porosity changes over time due to swelling associated with discharge and the electrolyte wetting.

% Cathode Porosity=(1−(cathode solids volume÷cathode volume))×100

The carbon particles are included in the cathode to allow the electrons to flow through the cathode. The carbon particles may be of synthetic expanded graphite. It is preferred that the amount of carbon particles in the cathode is relatively low, e.g., less than 3.75%, or even less than 3.5%, for example 2.0% to 3.5%. This carbon level allows the cathode to include a higher level of active material without increasing the volume of the cell or reducing the void volume (which must be maintained at or above a certain level to prevent internal pressure from rising too high as gas is generated within the cell).

Suitable expanded graphite particles can be obtained, for example, from Chuetsu Graphite Works, Ltd. (e.g., Chuetsu grades WH-20A and WH-20AF) of Japan or Timcal America (e.g., Westlake, Ohio, KS-Grade). A suitable graphite is available from Timcal under the tradename Timrex® BNB-90 graphite.

Some preferred cells contain from about 2% to about 3.5% expanded graphite by weight. In some implementations, this allows the level of EMD to be from about 89% to 91% by weight as supplied. (EMD contains about 1-1.5% moisture as supplied, so this range equates to about 88% to 90% pure EMD.) Preferably, the ratio of cathode active material to expanded graphite is greater than 25, and more preferably greater than 26 or even greater than 27. In some implementations, the ratio is between 25 and 33, e.g., between 27 and 30. These ratios are determined by analysis, ignoring any water.

It is generally preferred that the cathode be substantially free of natural graphite. While natural graphite particles provide lubricity to the cathode forming equipment, this type of graphite is significantly less conductive than expanded graphite, and thus it is necessary to use more in order to obtain the same cathode conductivity. If necessary, the cathode may include low levels of natural graphite, however this will compromise the reduction in graphite concentration that can be obtained while maintaining a particular cathode conductivity.

The cathode may be provided in the form of pressed pellets. For optimal processing, it is generally preferred that the cathode have a moisture level in the range of about 2.5% to about 5%, more preferably about 2.8% to about 4.6%. It is also generally preferred that the cathode have a porosity of from about 22% to about 31%, for a good balance of manufacturability, energy density, and integrity of the cathode.

Examples of binders that may be used in the cathode include polyethylene, polyacrylic acid, or a fluorocarbon resin, such as PVDF or PTFE. An example of a polyethylene binder is sold under the trade name COATHYLENE HA-1681 (available from Hoechst or DuPont).

Examples of other additives are described in, for example, U.S. Pat. Nos. 5,698,315, 5,919,598, and 5,997,775 and U.S. application Ser. No. 10/765,569.

Anode 14 can be formed of an anode active material, a gelling agent, and minor amounts of additives, such as gassing inhibitor. The amount of anode active material may vary depending upon the active material used within and cell size of the alkaline cell. For example, AA batteries with a zinc anode active material may have at least about 3.3 grams of zinc. For example, the zinc anode active material may have at least about 4.0, 4.3, or 4.8 grams of zinc. AAA batteries, for example, with a zinc anode active material may have at least about 1.9 grams of zinc. For example, the zinc anode active material may have at least about 2.0 or 2.1 grams of zinc.

Examples of the anode active material include zinc. Preferably, to compensate for the increased active material in the cathode, the anode active material includes zinc having a fine particle size, e.g., an average particle size of less than 175 microns. The use of this type of zinc in alkaline cells is described in U.S. Pat. No. 6,521,378, the complete disclosure of which is incorporated herein by reference.

The anode active material particles may have a particle surface area that may be determined by calculating the surface area of a sphere for a mean particle size (d cm), as represented by the formula:

Particle Surface Area (cm²)=π(d cm)²=cm².

For example, zinc particles having a particle surface area of less than about 9.62×10⁻⁴ cm² are preferred, more preferably less than about 3.14×10⁻⁴ cm², and most preferably less than about 7.85×10⁻⁵ cm².

Examples of a gelling agent that may be used include a polyacrylic acid, a grafted starch material, a salt of a polyacrylic acid, a carboxymethylcellulose, a salt of a carboxymethylcellulose (e.g., sodium carboxymethylcellulose) or combinations thereof.

The anode may include a gassing inhibitor which can include an inorganic material, such as bismuth, tin, or indium. Alternatively, the gassing inhibitor can include an organic compound, such as a phosphate ester, an ionic surfactant or a nonionic surfactant.

Separator 16 can be a conventional alkaline cell separator. Preferably, the separator material is thin. For example, for an AA alkaline cell, the separator may have a wet thickness of less than 0.30 mm, preferably less than 0.20 mm and more preferably less than 0.10 mm, and a dry thickness of less than 0.10 mm, preferably less than 0.07 mm and more preferably less than 0.06 mm. The basis weight of the separator may be from about 15 to 80 g/m². In some preferred implementations the separator may have a basis weight of 35 g/m² or less. In other embodiments, separator 16 may include a layer of cellophane combined with a layer of non-woven material. The separator also can include an additional layer of non-woven material.

In some implementations, the separator is wrapped about a mandrel to form a tube. In such cases, in order to minimize cell distortion, it is generally preferred that the number of wraps of the separator is an integer or “whole number” (e.g., 1, 2, 3, 4 . . . ), rather than a fractional number (e.g., 1.25). When the number of wraps is an integer, the cell discharge around the cell circumference tends to be more uniform than if the number of wraps contains a fractional amount. Due to practical limitations on manufacturing, it may not be possible to obtain exactly integral (whole number) wraps, however it is desirable to be as close to integral as possible, e.g., 0.8 to 1.2, 1.8 to 2.2, 2.8 to 3.2, etc. Separator designs of this kind will be referred to herein as having “substantially integral wraps.”

An electrolyte may be dispersed throughout the cathode 12, the anode 14 and the separator 16. The electrolyte comprises an ionically conductive component in an aqueous solution. The ionically conductive components may be an alkali hydroxide, such as potassium hydroxide or sodium hydroxide, or a salt such as zinc chloride, ammonium chloride, magnesium perchlorate, magnesium bromide, or their combinations.

The average concentration of the ionically conductive component may be determined by collecting the total amount of electrolyte from within an assembled alkaline cell, for example a AA or a AAA alkaline cell. This may generally be accomplished by removing the separator, cathode, and anode components and dissolving these components within a hydrochloric solution. Hydrogen peroxide may be added in a drop wise manner to aid in the dissolving process. The dissolved solution may then be diluted to specific volume provide an analyte. The analyte may then be analyzed via an inductively coupled plasma (ICP) emission spectrometer, such as a JY Ultratrace or its equivalent, to determine the total positive ion concentration of the ionically conductive component within the analyte, for example potassium (K⁺) concentration in ppm. The total positive ion concentration determined via ICP from the analyte may be used to mathematically determine the total weight of the positive ion, for example potassium (K⁺) in grams, and subsequently the total weight of ionically conductive component, for example potassium hydroxide (KOH) in grams, within the electrolyte solution of the sampled alkaline cell. The concentration of the ionically conductive component of the electrolyte, for example potassium hydroxide (KOH), on a weight basis of the electrolyte may be determined by dividing the total weight of the ionically conductive component by the analyte weight.

The average concentration of ionically conductive component in the aqueous solution may be from about 0.23 to about 0.37 on a total weight basis of the electrolyte. For example, the electrolyte may comprise potassium hydroxide in an aqueous solution at an average concentration between 0.26 and 0.32 on a total weight basis of the electrolyte.

Total surface area of an anode active material may be determined by the Brunauer-Emmett-Teller (BET) method. An anode active sample, for example zinc, is prepared to a specified weight, such as 10 g. The sample is the placed within an area and pore analyzer, such as a Quantachrome Autosorb 1, to determine the total BET surface area of the sample per weight (cm²/g). Such an analysis may be completed on either a batch of anode active material sampled prior to cell assembly or may be completed on a series of anode active material sampled from a series of production cells in order to obtain the amount of sample material required.

For an alkaline cell, a ratio of the total BET surface area of zinc particles within the anode to the total average concentration of the ionically conductive component in the aqueous solution (TA/Concentration) may be calculated by the following equation:

TA/Concentration=[(Active Anode Material Weight)(Total BET Surface Area)]·(Average Concentration of the Ionically Conductive Component)⁻¹=cm²/[Concentration]

A alkaline cell of AA design preferably has a ratio of total average surface area to an average concentration of the ionically conductive component in the aqueous solution of greater than about 4800 cm²/[Concentration]. For example, the ratio may be greater than about 6,000; 7,000; 8,000; 9,000; or 10,000. A alkaline cell of AAA design preferably has a ratio of total average surface area to an average concentration of the ionically conductive component in the aqueous solution of greater than about 1,700 cm²/[Concentration]. For example, the ratio may be greater than about 1,800; 1,900; 2,500; or 3,000. Batteries having such ratios exhibit very good service life.

Housing 18 can be a conventional housing commonly used in primary alkaline batteries, for example, nickel plated cold-rolled steel. Current collector 20 can be made from a suitable metal, such as brass. Seal 22 can be made, for example, of a polyamide (Nylon).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An AA alkaline cell comprising:
a housing and within the housing,
an anode comprising at least about 3.3 grams of zinc particles,
a cathode comprising a cathode active material,
a separator disposed between the cathode and the anode,
an electrolyte comprising an ionically conductive component in an aqueous solution, wherein:
the AA alkaline cell has a TA/Concentration ratio of greater than about 4800.

2. The AA alkaline cell of claim 1 wherein the cathode active material is selected from the group consisting of manganese dioxide, electrolytic manganese dioxide (EMD), chemical manganese dioxide (CMD) and high power electrolytic manganese dioxide (HP EMD).

3. The AA alkaline cell of claim 1 wherein the cathode further comprises graphite in a concentration of less than about 3.75% by weight.

4. The AA alkaline cell of claim 1 wherein the cathode further comprises carbon particles.

5. The AA alkaline cell of claim 4 wherein the carbon particles comprise expanded graphite.

6. The AA alkaline cell of claim 1 wherein the zinc particles have a particle surface area of less than 9.62×10⁻⁴ cm².

7. The AA alkaline cell of claim 1 wherein the ionically conductive component comprises an alkali hydroxide.

8. The AA alkaline cell of claim 1 wherein the ionically conductive component comprises a salt.

9. An AAA alkaline cell comprising:
a housing and within the housing,
an anode comprising at least about 1.9 grams of zinc particles,
a cathode comprising a cathode active material,
a separator disposed between the cathode and the anode,
an electrolyte comprising an ionically conductive component in an aqueous solution, wherein:
the AAA alkaline cell has a TA/Concentration ratio of greater than about 1,700.

10. The AAA alkaline cell of claim 9 wherein the cathode active material is selected from the group consisting of manganese dioxide, electrolytic manganese dioxide (EMD), chemical manganese dioxide (CMD) and high power electrolytic manganese dioxide (HP EMD).

11. The AAA alkaline cell of claim 9 wherein the cathode further comprises graphite in a concentration of less than about 3.75% by weight.

12. The AAA alkaline cell of claim 9 wherein the cathode further comprises carbon particles.

13. The AAA alkaline cell of claim 12 wherein the carbon particles comprise expanded graphite.

14. The AAA alkaline cell of claim 9 wherein the zinc particles have a particle surface area of less than 9.62×10⁻⁴ cm².

15. The AAA alkaline cell of claim 9 wherein the ionically conductive component comprises an alkali hydroxide.

16. The AAA alkaline cell of claim 9 wherein the ionically conductive component comprises a salt.
